(19) United States
(12) Patent Application Publication
(10) Pub. No.: US 2008/0015295 A1
(43) Pub. Date: Jan. 17, 2008

(54) Polymeric gel composition and method for making

(76) Inventors: Virgil AG Williams, Leonardo, NJ (US); Jamie L. Arbolino, Netcong, NJ (US)

Correspondence Address: BARNES & THORNBURG LLP, 11 SOUTH MERIDIAN, INDIANAPOLIS, IN, 46204, US

(21) Appl. No.: 11/484,463

(22) Filed: Jul. 11, 2006

(51) Int. Cl. C08K 5/00; C08L 9/00

(52) U.S. Cl. 524/236; 524/571

(57) ABSTRACT

An anhydrous gel composition is provided for holding and dispersing into the surrounding air space, in a time controlled manner, a volatile composition contained within the gel. The gel composition is formed by crosslinking a polymer solution that contains the volatile composition. In one embodiment the gel composition comprises about 8% to about 25% by weight of an anhydride functionalized polymer; about 0.3% to about 10% by weight of total crosslinker reagent; and about 50% to about 90% by weight of a functional volatile component.

### BACKGROUND

Devices comprising polymer gels have been described for diffusing volatile compounds, including for example perfumes, deodorizing compositions, insect repellents, and the like, into the atmosphere. For example, air-freshening devices or deodorizers are currently used in many households to mask bad odors, or to impart fragrances to the ambient air. Typically, the active ingredients are entrapped within the gel matrix and the volatile compounds are slowly released by diffusion in a relatively controlled manner. Examples of such known materials include gels, such as agar or sodium stearate gels, synthetic polymer resins, or blocks of mineral material, e.g., plaster or silica.

One disadvantage encountered with solid gel dispensing devices is that the release of active ingredients from the blocks is not constant with time and drops dramatically over the lifetime of the device. Devices comprising an anhydrous gel have improved release characteristics but existing systems suffer disadvantages with regards to compatibility with the active agents and the reagents used to prepare the anhydrous gels. In addition some formulations also suffer from having poor mechanical properties.

Therefore, there is still a need for gel compositions which can be obtained at room temperature, have good mechanical properties and provide effective release of the active ingredient for a prolonged period of time.

### SUMMARY

The present invention relates to a polymerized gel composition that serves as an effective carrier for holding and releasing a volatile composition over a prolonged period of time. In accordance with one embodiment the polymerized gel composition comprises about 10% to about 25% by weight of an anhydride functionalized polymer, about 0.3% to about 6.5% by weight of total crosslinker reagent; and about 50% to about 90% by weight of a functional volatile component. In one embodiment the crosslinker reagent is a compound comprising the general structure:

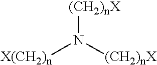

wherein X is selected from the group consisting of —OH, —NH and —SH and n is an integer selected from the range of 1-3. In one embodiment the crosslininker reagent is triethanolamine. In another embodiment the crosslinker reagent comprises triethanolamine and a polyoxypropylenediamine. In one embodiment the anhydride functionalized polymer is selected from the group consisting of maleinized polybutadiene-styrene, maleinized polychloroisoprene, maleinized polybutadiene and maleinized polyisoprene.

In one embodiment the gel is polymerize in a mold to form a gel of a predetermined shape. The anhydrous gel element of the present invention may be used as the active element of a solid state air freshening, deodorizing or insect repellant device, with the gel element being incorporated within a housing with one or more grills which communicate with the surrounding air. Alternatively, the gel element may be formed in situ within the recesses or grooves of a solid casing or housing.

A method for making an anhydrous crosslinked, polymeric gel composition is also provided. In one embodiment the method comprises the steps of providing a first composition comprising about 10% to about 15% by total composition weight of an anhydride functionalized polymer, and about 50% by total composition weight functional volatile composition, and providing a second composition comprising about 0.1% to about 3.0% by total composition weight triethanolamine, and about 25% to about 35% by total composition weight of a functional volatile component. The first and the second premix formulations are then mixed to induce the formation of an anhydrous, crosslinked, polymeric gel composition.

### DETAILED DESCRIPTION

An anhydrous gel composition is provided for holding and dispersing, in a time controlled manner, a volatile composition contained within the gel into the surrounding air space. The gel composition is formed by crosslinking a polymer solution that contains the volatile composition. In one embodiment the gel composition comprises about 10% to about 25% by weight of an anhydride functionalized polymer; about 0.3% to about 10% by weight of total crosslinker reagent; and about 50% to about 90% by weight of a functional volatile component. The shape of the gel is selected to optimize the ratio of the evaporating surface of the solid carrier to the mass of the solid carrier such that, during the active lifetime of a device comprising the gel, a substantially constant release rate and total evaporation of the active volatile composition are obtained.

The anhydride functionalized polymer used to form the gel compositions of one embodiment include polymers made by reacting maleic anhydride with a suitable polymer, such as butadiene, isoprene, chloroisoprene, or other polyunsaturated hydrocarbons, as well as mixtures thereof, resulting in a covalent attachment of maleic anhydride to the polymer. Examples of suitable anhydride functionalized polymers include maleinized polybutadiene (such as RICAN® 131MA10, available from Sartomer Co., Exton, Pa., and LITHENE® N4-9000-MA10, available from Kuraray Co. Ltd., Tokyo, Japan), maleinized polybutadiene-styrene (such as Rican 184), maleinized polychloroisoprene, maleinized polybutadiene-isoprene, and maleinized vegetable oil. In one embodiment the anhydride functionalized polymer is maleinized polybutadiene or maleinized polyisoprene.

In one embodiment the anhydride functionalized polymer is a maleinized polybutadiene having an average molecular weight of about 5,000 to about 20,000 or a maleinized polyisoprene having an average molecular weight of about 200,000 to about 500,000. Examples of these materials are given in European published patent application EP-A-0023084. One suitable commercially available maleinized polybutadiene is LITHENE®, and more particularly, LITHENE® N4-9000 10MA, in which 9000 represents the molecular weight of the polybutadiene before maleinization and 10MA indicates the degree of maleinization (in this case, 10 parts of maleic anhydride per 100 parts of polybutadiene, i.e., about 9.1%). LITHENE® N4-B-10MA and LITHENE® N4-5000-10MA are also used in alternative embodiments of the gel compositions disclosed herein.

Suitable crosslinking agents for use in preparing the disclosed gel compositions include any material that reacts with an anhydride functionalized polymer to form a crosslinked polymer. Typically, the anhydride functionalized polymer and the crosslinking agent are included in a molar ratio of between about 3:1 and 0.5:1, and in one embodiment at a molar ratio of about 1:1, based on the molar ratio of the functional groups which are present.

Representative crosslinking agents include, but are not limited to, compounds that contain an amine, alcohol, or thio functional group. Suitable crosslinking agents can also contain a combination of one or more thio, amine and alcohol functional groups. Also useful are the solid, heat-activated crosslinking agents disclosed in U.S. Pat. No. 5,844,047, the disclosure of which is herein incorporated by reference. In one embodiment the crosslinking agent is selected from the group including polythios, polyols, and polyamines, and in one embodiment the crosslinking agent is a polyamine. Suitable polyamine cross-linking agents include (1) diamines, including polyoxypropylenediamine (such as JEFFAMINE® XTJ-504 and JEFFAMINE® D-400; available from Huntsman Performance Products; The Woodlands, TX) and (2) triamines, including polyoxypropylenetriamine (such as JEFFAMINE® T-403 and XTJ-509) and triethanolamines. Also useful are hindered polyamines, such as the hindered polyamines described in U.S. Pat. No. 5,633,341, the disclosure of which is incorporated herein by reference, and polyamines contained within molecular sieves, such as the polyamines described in U.S. Pat. No. 5,792,816, the disclosure of which is incorporated herein by reference.

In accordance with one embodiment the anhydride functionalized polymer is crosslinked through the use of a crosslinker reagent that comprises a compound of the general structure:

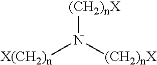

wherein X is selected from the group consisting of —OH, —NH and —SH and n is an integer selected from the range of 1-3. In accordance with one embodiment the crosslinker reagent comprises a compound of the above general structure wherein X is OH. The crosslinker reagent in one embodiment comprises additional crosslinking moieties, and in one embodiment the crosslinker reagent comprises a polyoxy(C₁-C₄ alkene)diamine and a compound of the general structure:

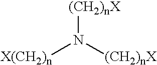

wherein X is —OH and n is an integer selected from the range of 1-3. In one embodiment the polyoxy (C₁-C₄ alkene) diamine is a polyoxyethylenediamine or a polyoxypropylenediamine. In one embodiment the crosslinker reagent comprises triethanolamine. In another embodiment the crosslinking reagent comprises triethanolamine and a polyoxypropylenediamine, such as JEFFAMINE® D-400, for example.

The functional volatile component of the polymeric gel composition may comprises a perfume base, deodorizer, insecticide, insect repellant or other volatile composition that is to be dispersed into the air in a time dependent fashion. In one embodiment the functional volatile component is non-aqueous and will generally constitute about 50% to about 95% by weight, or about 60% to about 90% by weight, and in one embodiment about 70% to about 85% by weight of the gel element.

In one embodiment the functional volatile component includes one or more of the standard non-aqueous perfume compositions currently known and used by those skilled in the art. These can be discrete chemicals, but more often comprise complex mixtures of volatile liquid ingredients of natural or synthetic origin. The nature of these ingredients can be found in specialized books of perfumery, e.g., in S. Arctander, Perfume and Flavor Chemicals, Montclair N.J., USA (1969) or Perfumery, Wiley-Intersciences, New York, USA (1994).

In one embodiment the functional volatile component includes one or more insect repellants or insecticides. Useful insect repellants include any volatile insect repellant, such as pyrethroid insecticides, Citronella, citronellol, nerol, geraniol, and N, N-Diethyl-m-toluamide or combinations thereof. One suitable insect repellant is DEET.

In typical embodiments the gel formulation will not be coated or covered by a polymer film, as such coatings may interfere with the dispersal of the volatile active agents. Accordingly, in one embodiment the gel composition further comprises an aversive agent to discourage ingestion of the product by children or animals. Suitable aversive agents are known to those skilled in the art, and include for example, Bitrex® (denatonium benzoate; Macfarlan Smith, Ltd. of Edinburgh, Scotland).

Suitable hydrophobic liquids for use in formulating the functional volatile component include, but are not limited to, hydrocarbons, including oils, such as aliphatic hydrocarbon oils and naphthenic hydrocarbon oils, such as paraffin oils, mineral oils, vegetable oils, and kerosene, fatty esters, fatty acids, triglycerides, diglycerides, monoglycerides, alcohols, including polypropylene glycol and propoxylated or ethoxylated alcohols, ethers, amides, polyamides, cyclic hydrocarbons, propoxylated or ethoxylated acids, propoxylated or ethoxlyated glycerides, silicon hydrocarbons, saturated or unsaturated synthetic oils, hydrocarbon-containing fragrance raw materials, including those containing alcoholic, cyclic, aldehydic, ether, unstauration, sulfur, and keto functionalities, and essential oils.

In accordance with one embodiment a gel composition is provided that comprises about 10% to about 15% by weight of an anhydride functionalized polymer, about 0.1% to about 3.0% by weight of a compound having the general structure:

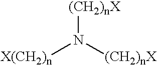

wherein X is —OH and n is an integer selected from the range of 1-3, about 1.5% to about 6.0% by weight of a polyoxypropylenediamine and about 50% to about 85% by weight of a functional volatile component. In another embodiment the gel composition comprises about 10% to about 15% by weight of an anhydride functionalized polymer, about 0.1% to about 3.0% by weight triethanolamine, about 1.5% to about 6.0% by weight of a polyoxypropylenediamine and about 50% to about 85% by weight of a functional volatile component. In a further embodiment the gel composition comprises about 10% to about 13% by weight of a maleinized polybutadiene, about 0.1% to about 1.0% by weight triethanolamine, about 1.5% to about 6.0% by weight of a polyoxypropylenediamine, and about 50% to about 85% by weight of a functional volatile component. In another embodiment the gel composition comprises about 10% to about 13% by weight of a maleinized polybutadiene, about 0.1% to about 1.0% by weight triethanolamine, and about 50% to about 85% by weight of a functional volatile component. The composition may include further components such as surfactants, solubilizing agents, plasticizers and diluents.

In accordance with one embodiment a surfactant is included in the gel compositions at a concentration selected from a range of about 0.01 to about 2 wt. %, or about 0.1 to about 1 wt. %, and in one embodiment about 0.2 to about 1 wt. % surfactant. Suitable surfactants include nonionic surfactants, amphoteric surfactants, zwitterionic surfactants, cationic surfactants, anionic surfactants and combinations thereof. In one embodiment the surfactant, when present, is an anionic or a nonionic surfactant. Examples of nonionic surfactants are ethoxylated nonylphenol containing 4 moles of ethylene oxide (such as Surfonic N40, available from Huntsman Corp., Salt Lake City, Utah) and ethoxylated alcohols containing 3 moles of ethylene oxide (such as Surfonic L243 and Tergitol 15-S-3, available from Dow Chemical Co., Midland, Mich.). Examples of anionic surfactants are ethoxylated alkyl sulfates (such as Steol CS460, available from Stephan Company, Northfield, Ill.). In one embodiment the surfactant is an ammonium lauryl ether sulfate or a sodium lauryl ether sulfate.

In accordance with one embodiment the gel compositions are further provided with plasticizers, including silicone elastomers, polyurethane elastomers and thermoplastic urethane elastomers. In one embodiment the gel composition comprises a silicon urethane copolymer such as PurSil or CarboSil (available from The Polymer Technology Group, Berkely, Calif.). The plasticizers can be added to the composition in an amount ranging from about 1 to about 5 wt. %, and more typically in an amount about 3 to about 5 wt %.

Additional components that can be added to the anhydrous gel composition include isopropyl myristrate. This compound is added to improve the spreading co-efficient of the volatile composition and/or to serve as an effective diluent, particularly for fragrance oils. Isopropyl myristate can be added to the gel compositions in an amount ranging from about 0.5 to about 3 wt %. Alternatively other volatile solvent/diluents can be used in the formulation of the gel compositions including various cosmetic fluids available from 3M corporation, including CF-61 (methoxynonafluorobutane) and CF-76 (ethoxynonafluorobutane). Typically CF-61 and CF-76 are added to the formulation at a concentration of about 0.5 to about 2 wt %.

A method for making the anhydrous gel composition is also provided herein. The method comprises the steps of mixing together about 10% to about 25% by weight of an anhydride functionalized polymer; about 0.3% to about 10% by weight of total crosslinker reagent; and about 50% to about 85% by weight of a functional volatile component, based on the total weight of the polymeric gel composition. In one embodiment the anhydride functionalized polymer is a maleinized polybutadiene polymer, a maleinized polyisoprene polymer, a maleinized polybutadiene/styrene polymer or a mixture thereof. The mixture is allowed set using ambient temperature and pressure to form a cross-linked polymer gel. In one embodiment, the mixture is placed in a mold where gelling occurs. The resulting structurally stable gel is then removed from the mold.

In accordance with one embodiment, the process of forming the polymerized gel includes the step of mixing two separate premixes, wherein one premix comprises the anhydride functionalized polymer and the other comprises the cross-linking agent. In one embodiment the anhydride functionalized polymer is a maleinized polybutadiene polymer, a maleinized polyisoprene polymer, a maleinized polybutadiene/styrene polymer or a mixture thereof. For example, in one embodiment, formation of the crosslinked gel comprises the step of combining two premix composition to initiate polymerization. In one embodiment the first premix comprises an anhydride functionalized polymer, and a functional volatile composition, and the second premix comprises a crosslinking agent having the general structure:

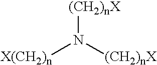

wherein X is selected from the group consisting of —OH, —NH and —SH and n is an integer selected from the range of 1-3. More particularly, in one embodiment the first premix comprises about 10% to about 15% by total composition weight of an anhydride functionalized polymer, and about 50% by total composition weight of a first functional volatile composition, and the second composition comprises about 0.1% to about 3.0% by weight triethanolamine, and about 25% to about 35% by weight of a second functional volatile component. In another embodiment the first premix comprises about 10% to about 15% by total composition weight of a maleinized polybutadiene, and about 50% by total composition weight of a first functional volatile composition, and the second composition comprises about 0.1% to about 3.0% by weight triethanolamine, about 1.5% to about 6.0% by weight polyoxypropylenediamine, and about 25% to about 35% by weight of a second functional volatile component. The volatile compositions contained within the first and second premix formulations may be the same or different. Additional components that may be included in the polymerized gel (including for example a surfactant) are typically added to the second premix prior to mixing the first and second premixes.

The anhydrous gel element of the present invention may be used as the active element of a solid state air freshening, deodorizing or insect repellant device, with the gel element being incorporated within a housing with one or more grills which communicate with the ambient air. Alternatively, the gel element may be formed in situ within the recesses or grooves of a solid casing or housing. This type of device does not require the use of a grill to cover the gel element. The recesses or grooves of the solid casing or housing are filled with the mixture of anhydride functionalized polymer, cross-linking agent, perfume or deodorizing base, and the cross-linking reaction forming the gel takes place in situ. The gel so-formed thus adheres to the sides and/or bottom of the recesses or grooves in order to provide an integral structure.

### EXAMPLE 1

An anhydrous air freshener gel was formed using triethanolamine as a crosslinking agent to enhance the crosslinking attributes of the gel when fragrances are introduced. Hydrophilic glycol ether, aprotic glycol ether and/or isoparaffinic hydrocarbon are also used in fragrances to boost the performance of the fragrance in the gel system and a crosslinking agent that is compatible with such diverse compounds is desirable. A crosslinked fragrance carrying gel was made using the following procedure.

A first premix a was made by combining 50% by weight of a fragrance oil and 17% by weight of LITHENE®N-4-9000-MA10 and mixed until homogeneous. A second premix was made by combining 6% by weight polypropylenediamine (JEFFAMINE® D-400) with 1% by weight alcohol ethoxylated sulfate (Steol CS 460), 0.2% by weight triethanolamine and 25.8% by weight fragrance and mixing until homogeneous. The first and second premixes were then combined and mixed vigorously for 15-30 seconds. The mixture was then allowed to polymerize at room temperature and standard atmospheric pressure.

### EXAMPLE 2

An anhydrous air freshener gel was formed using triethanolamine as a crosslinking agent to enhance the crosslinking attributes of the gel when fragrances are introduced. Three separate formulations were prepared in an attempt to lower the presence of non-volatile ingredients present in the gel and raise the fragrance content. Each of the three formulations prepared as described in Example 1 provided an effective gel formulation. A fourth formulation was prepared that includes the adversive, Bitrex® The compositions of these four formulations are shown in Table 1 below, with compounds listed per weight %, wherein IPM is isopropyl myristrate and TEA is triethanolamine.

TABLE 1

| | Formula A | Formula B | Formula C | Formula D |
|---|---|---|---|---|
| First Premix | | | | |
| LITHENE ® | 12.00 | 12.00 | 12.00 | 12.00 |
| fragrance | 50.00 | 50.00 | 50.00 | 50.00 |
| Second Premix | | | | |
| JEFFAMINE ® | 2.00 | 2.00 | 2.00 | 2.00 |
| IPM | 2.50 | 0.70 | 0.80 | 0.79 |
| fragrance | 28.00 | 30.00 | 32.00 | 32.00 |
| TEA | 0.50 | 0.30 | 0.10 | 0.10 |
| Carbosil | 5.00 | 5.00 | 3.00 | 3.00 |
| Bitrex ® | | | | 0.01 |

1. A gel composition, comprising:
about 8% to about 25% by weight of an anhydride functionalized polymer;
about 0.3% to about 6.5% by weight of total crosslinker reagent; and
about 50% to about 90% by weight of a functional volatile component, wherein the crosslinker reagent comprises triethanolamine as an active crosslinking agent.

2. The gel composition of claim 1 wherein the anhydride functionalized polymer is selected from the group consisting of maleinized polybutadiene-styrene, maleinized polychloroisoprene, maleinized polybutadiene and maleinized polyisoprene.

3. The gel composition of claim 2 wherein the crosslinker reagent further comprises a polyoxypropylenediamine.

4. The gel composition of claim 3 comprising
about 8% to about 17% by weight of an anhydride functionalized polymer;
about 0.1% to about 3.0% by weight triethanolamine;
about 1.5% to about 6.0% by weight polyoxypropylenediamine; and about 50% to about 90% by weight of a functional volatile component.

5. The gel composition of claim 4 further comprising a surfactant.

6. The gel composition of claim 4 further comprising a thermoplastic polymer.

7. The gel composition of claim 4 wherein the anhydride functionalized polymer is maleinized polybutadiene.

8. The gel composition of claim 7 wherein the functional volatile composition is a perfume base or deodorant.

9. The gel composition of claim 7 wherein the functional volatile composition is an insecticide or an insect repellant.

10. A method for making an anhydrous crosslinked, polymeric gel composition comprising:
providing a first composition comprising about 8% to about 15% by total composition weight of an anhydride functionalized polymer, and about 50% by total composition weight functional volatile composition;
providing a second composition comprising about 0. 1% to about 3.0% by total composition weight triethanolamine, and about 25% to about 40% by total composition weight of a functional volatile component
mixing the first and second compositions to induce the formation of an anhydrous, crosslinked, polymeric gel composition.

11. The method of claim 10 wherein the second composition further comprises about 1.5% to about 6.0% by weight of a polyoxypropylenediamine.

12. The method of claim 10 wherein the anhydride functionalized polymer is a maleinized polybutadiene polymer, a maleinized polyisoprene polymer, a maleinized polybutadiene/styrene polymer or a mixture thereof.

13. The method of claim 12 wherein the anhydride functionalized polymer is maleinized polybutadiene.

14. The method of claim 10 wherein the second composition further comprises an anionic surfactant.

15. The method of claim 10 wherein the second composition further comprises a thermoplastic polymer.

16. The method of claim 10 wherein the first and second compositions are mixed together and the mixture is allowed to polymerize in a mold to form a gel of a predetermined shape.

17. A gel composition comprising
about 8% to about 15% by weight of an anhydride functionalized polymer;
about 0.1% to about 3.0% by weight of a crosslinking agent having the general structure: 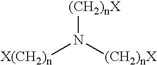
wherein X is selected from the group consisting of —OH, —NH and —SH and n is an integer selected from the range of 1-3; and
about 50% to about 90% by weight of a functional volatile component.

18. The gel composition of claim 17 wherein the crosslinking agent is triethanolamine.

19. The gel composition of claim 17 further comprising about 1.5% to about 6.0% by weight of a polyoxypropylenediamine.
